(19) United States
(12) Patent Application Publication
(10) Pub. No.: US 2012/0323484 A1
(43) Pub. Date: Dec. 20, 2012

(54) Program-Storing Computer-Readable Storage Medium, Computer Program Product, Navigation Device and Control Method Thereof

(75) Inventor: Yin-He Zhang, Shanghai (TW)

(73) Assignees: MITAC RESEARCH (SHANGHAI) LTD., Shanghai (CN); MITAC INTERNATIONAL CORP., Kuei San Township (TW)

(21) Appl. No.: 13/178,069

(22) Filed: Jul. 7, 2011

(30) Foreign Application Priority Data
Jun. 16, 2011 (CN) 201110162929.0

(51) Int. Cl. G01C 21/34; G01C 21/36

(52) U.S. Cl. 701/423; 701/431

(57) ABSTRACT

A navigation device includes a processing unit electrically connected to a positioning unit and a communication unit. The positioning unit determines a current location of the navigation device and provides corresponding positioning information. The communication unit receives real-time information. The processing unit uses the real-time information and information about a waypoint as a basis to generate a safety speed range, and uses a navigation route and the positioning information as a basis to determine whether a distance between the navigation device and the waypoint is smaller than a preset distance range. If yes, the processing unit provides a speed limit message based on the safety speed range. A navigation device control method as well as a program-storing computer-readable storage medium and a computer program product enabling implementation of the control method are also disclosed.

### FIELD OF THE INVENTION

The present invention relates to a program-storing computer-readable storage medium, a computer program product, a navigation device and a control method thereof; and more particularly, to a navigation device and control method thereof that is able to receive different real-time information about, for example, weather, traffic flow and/or road condition, and correspondingly provide speed limit message or warning message in advance.

### BACKGROUND OF THE INVENTION

Currently, a prior art navigation system provides car navigation service by receiving Global Positioning System (GPS) real-time signals to determine the device's current location and using navigation software with map information. According to the most common way of navigation provided by the conventional navigation system, the car's current location is defined as a start location, and a user inputs a target location to the navigation device, so that the navigation system computes to find the shortest route from the start location to the target location for the user's reference. However, the above-described navigation system still has some problems in practical operation thereof and accordingly, requires improvements. For example, when driving in different objective environmental conditions, such as driving in a heavy rainy day, driving on a flooded road or a snow-deposited road, or passing road works or a road accident, the prior art navigation system would not be able to remind the driver of such conditions in advance and limit the driver to a certain a driving speed. Without such services, the driver might drive at a relative high speed to cause unpredictable safety problems. That is, the conventional navigation system can only guide the user to a desired destination without the function of ensuring the user's safety in driving.

### SUMMARY OF THE INVENTION

A primary object of the present invention is to provide a program-storing computer-readable storage medium, a computer program product, a navigation device and a control method thereof, so as to solve the safety problems that would otherwise occur when the navigation device user has no idea about real-time road condition when being guided by the navigation device under different objective conditions, such as weather, traffic flow, road condition and the like.

To achieve the above and other objects, the navigation device according to the present invention includes a positioning unit, a communication unit, and a processing unit. The positioning unit determines a current location of the navigation device and provides corresponding positioning information. The communication unit receives real-time information. The processing unit is electrically connected to the positioning unit and the communication unit, and uses the real-time information and information about a waypoint as a basis to generate a safety speed range. The processing unit also uses a navigation route and the positioning information to determine whether a distance between the navigation device and the waypoint is smaller than a preset distance. If yes, the processing unit provides a speed limit message based on the safety speed range.

After determining the distance between the navigation device and the waypoint is smaller than the preset distance range, the processing unit further determines whether a current moving speed of the navigation device is higher than the safety speed range; and if yes, the processing unit provides a warning message.

When the processing unit determines that the distance between the navigation device and the waypoint is larger than the preset distance range, the processing unit cancels the provision of the speed limit message and the warning message.

According to the present invention, both the speed limit message and the warning message include image data and audio data.

According to the present invention, the navigation device further includes a storage unit and a route planning unit. The storage unit is electrically connected to the processing unit for storing a plurality of electronic maps therein; and the processing unit stores the real-time information received by the communication unit in the storage unit. The route planning unit is electrically connected to the processing unit and uses a start location, a target location and the plurality of electronic maps as a basis to generate the navigation route and the waypoint information; and the waypoint information includes the waypoint and coordinate data thereof.

According to the present invention, the navigation device further includes a display unit and an audio unit electrically connected to the processing unit. The display unit displays the navigation route, the image data of the speed limit message, and the image data of the warning message. The audio unit outputs the audio data of the speed limit message and the audio data of the warning message.

To achieve the above and other objects, the navigation device control method according to the present invention is applicable to a navigation device having a positioning unit, a communication unit, and a processing unit, and includes the steps of using the positioning unit to determine a current location of the navigation device and provide corresponding positioning information; using the communication unit to receive real-time information; the processing unit using the real-time information and information about a waypoint as a basis to generate a safety speed range; the processing unit further using a navigation route and the positioning information as a basis to determine whether a distance between the navigation device and the waypoint is smaller than a preset distance range; and if yes, the processing unit providing a speed limit message based on the safety speed range.

The navigation device control method according to the present invention further includes the following steps: after the processing unit determining the distance between the navigation device and the waypoint is smaller than the preset distance range, the processing unit further determining whether a moving speed of the navigation device is higher than the safety speed range; and if yes, the processing unit providing a warning message.

The navigation device control method according to the present invention further includes the following step: when the processing unit determining that the distance between the navigation device and the waypoint is larger than the preset distance range, the processing unit canceling the provision of the speed limit message and the warning message.

According to the present invention, both the speed limit message and the warning message include image data and audio data.

The navigation device control method according to the present invention further includes the following steps: using a storage unit to store a plurality of electronic maps therein; and the processing unit storing the real-time information received by the communication unit in the storage unit; and a route planning unit using a start location, a target location and the plurality of electronic maps as a basis to generate the navigation route and the waypoint information; and the waypoint information including the waypoint and coordinate data thereof.

The navigation device control method according to the present invention further includes the following steps: using a display unit to display the navigation route, the image data of the speed limit message, and the image data of the warning message; and using an audio unit to output the audio data of the speed limit message and the audio data of the warning message.

To achieve the above and other objects, the computer program product according to the present invention can be loaded and executed on a computer to thereby implement the above-described navigation device control method.

To achieve the above and other objects, the program-storing computer-readable storage medium according to the present invention allows a computer to load and execute the program stored therein to thereby implement the above-described navigation device control method.

In conclusion, the program-storing computer-readable storage medium, the computer program product, the navigation device and the control method thereof according to the present invention have one or more of the following advantages:

(1) The navigation device and the control method thereof are able to provide a speed limit message to the user if it is determined based on different objective conditions that a distance between the vehicle carrying the navigation device and a waypoint is within a preset distance range, so as to remind the user to reduce his or her driving speed; and

(2) The navigation device and the control method thereof are able to provide a warning message to the user if it is determined a moving speed of the vehicle carrying the navigation device is higher than a safety speed range, so as to timely warn the user and ensure the user's safety.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a navigation device according to the present invention;

FIG. 2 schematically shows a first embodiment of the navigation device of the present invention;

FIG. 3A schematically shows a second embodiment of the navigation device of the present invention with a speed limit message shown thereon;

FIG. 3B schematically shows the second embodiment of the navigation device of the present invention with a warning message shown thereon;

FIG. 4 is a flowchart showing the steps included in a navigation device control method of the present invention;

FIG. 5 is another flowchart showing further steps included in the navigation device control method of the present invention; and

FIG. 6 is a further flowchart showing still further steps included in the navigation device control method of the present invention.

### DETAILED DESCRIPTION OF THE PREFERRED EMBODIMENTS

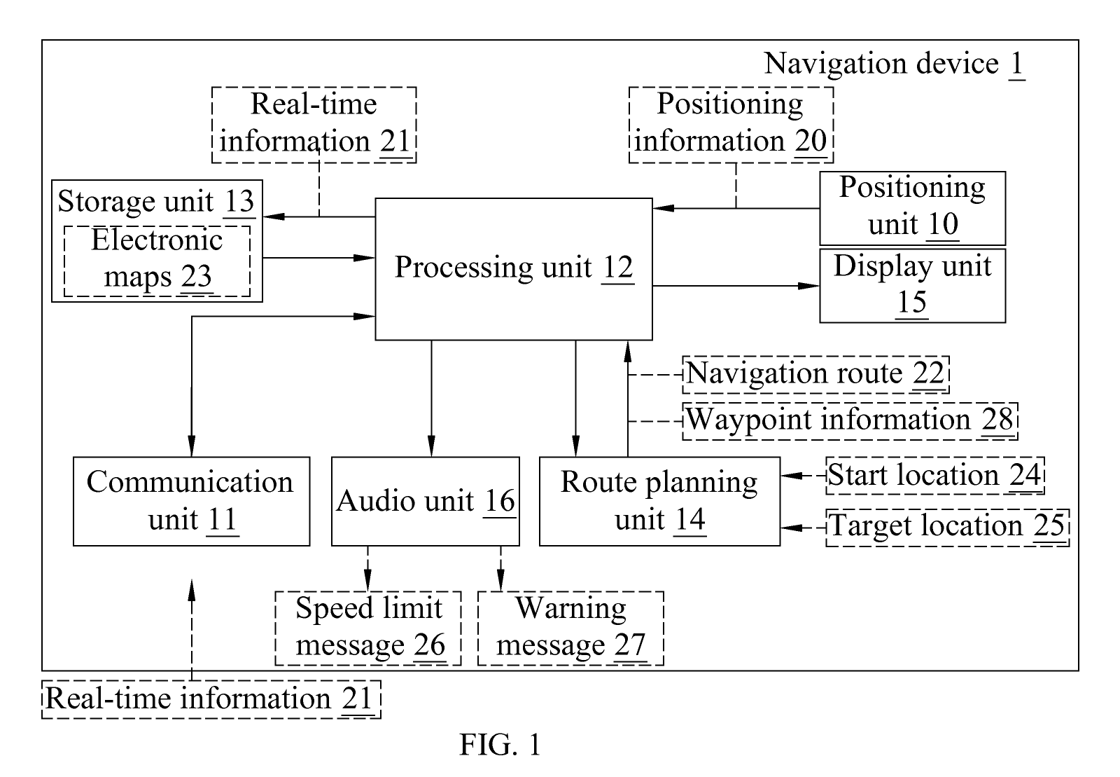

Please refer to FIG. 1 that is a block diagram of a navigation device 1 according to the present invention. As shown, the navigation device 1 includes a positioning unit 10, a communication unit 11, a processing unit 12, a storage unit 13, a route planning unit 14, a display unit 15, and an audio unit 16. The processing unit 12 is electrically connected to the positioning unit 10, the communication unit 11, the storage unit 13, the route planning unit 14, the display unit 15, and the audio unit 16.

The storage unit 13 can be any one of various currently available storage media, such as an embedded memory, an external memory (card), a disk, or a compact disk (CD), and has a plurality of electronic maps 23 stored therein. The processing unit 12 stores real-time information 21 received by the communication unit 11 in the storage unit 13. The route planning unit 14, the positioning unit 10, and the communication unit 11 can be independent computing chips or be integrated into the processing unit 12 as one single computing chip. The route planning unit 14 uses a start location 24, a target location 25, and the electronic maps 23 as a basis to generate a navigation route 22 and corresponding waypoint information 28. The waypoint information 28 includes at least a waypoint and coordinate data thereof. The display unit 15 can be any one of various currently available display devices, such as a liquid crystal screen, a projector, an organic light-emitting-diode (OLED) display, or an electronic paper display, for displaying the navigation route 22 thereon.

The positioning unit 10 determines a current location of the navigation device 1 and provides corresponding positioning information 20. In a preferred embodiment, the positioning unit 10 is a global Positioning System (GPS) for receiving satellite signals and computing the current location of the navigation device 1, and then providing the positioning information 20. The communication unit 11 can be any one of various currently available cabled or wireless communication devices, such as 3G, WIFI, WIMAX, LTE or LAN, for receiving real-time information 21. The real-time information 21 may include weather information, traffic flow information and/or road condition information, such as information about wind force, heavy fog, snowfall, rainfall, road congestion, road accident, road works, speed limit at curve road, or any combination thereof. The processing unit 12 can be a central processing unit (CPU) or a micro-processing unit, and uses the real-time information 21 and the waypoint information 28 as a basis to generate a safety speed range, and uses the navigation route 22 and the positioning information 20 to determine whether a distance between the navigation device 1 and a waypoint is smaller than a preset distance range. If yes, then the processing unit 12 provides a speed limit message 26 according to the safety speed range. The speed limit message 26 can include image data and audio data. Thereafter, the processing unit 12 controls the display unit 15 to display the image data of the speed limit message 26 and/or controls the audio unit 16 to output the audio data of the speed limit message 26.

After determining the distance from the navigation device 1 to the waypoint is smaller than the preset distance range, the processing unit 12 further determines whether a moving speed of the navigation device 1 is higher than the safety speed range. If yes, the processing unit 12 immediately provides a warning message 27, which can include image data and audio data. Thereafter, the processing unit 12 controls the display unit 15 to display the image data of the warning message 27 and/or controls the audio unit 16 to output the audio data of the warning message 27.

In the present invention, the audio unit 16 can be any one of various currently available sound outputting devices, such as an earphone, a stereo system or a speaker, for outputting the audio data of the speed limit message 26 and the audio data of the warning message 27.

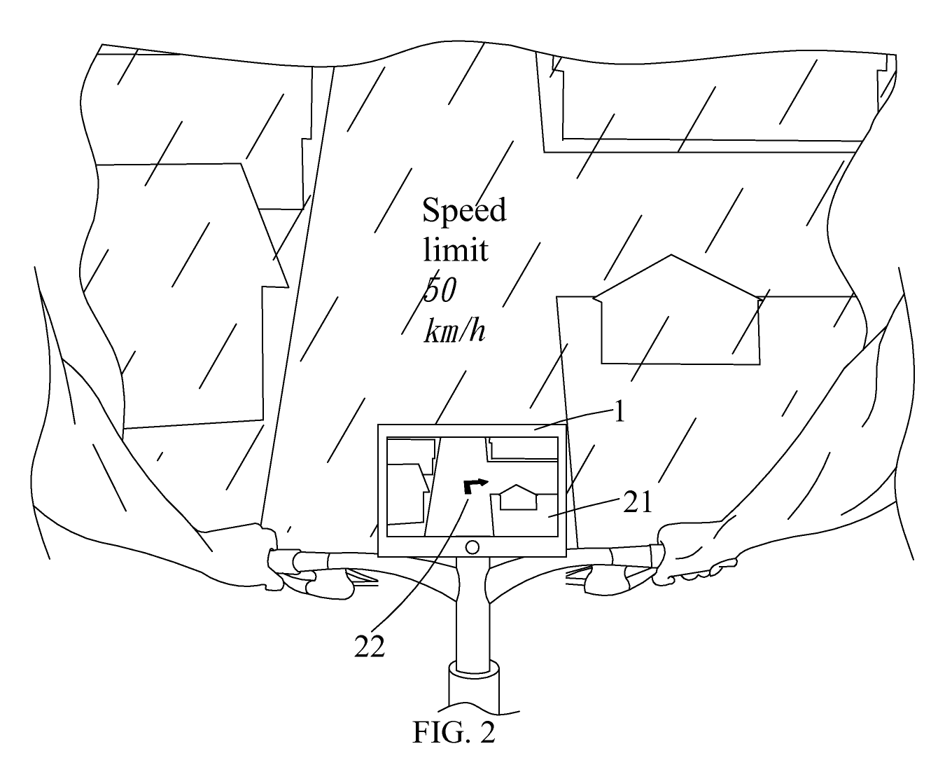

Please refer to FIG. 2 along with FIG. 1. FIG. 2 schematically shows a first embodiment of the navigation device of the present invention. As shown, the navigation device 1 is used in a rainy day. The processing unit 12 of the navigation device 1 will then generate a safety speed range, such as 20 km/h to 30 km/h, according to the received real-time information 21, such as information about rainfall and/or road condition. The processing unit 12 further uses the navigation route 22 and the positioning information 20 as a basis to determine whether a distance between the vehicle carrying the navigation device 1, such as a bicycle, and a waypoint, such as a landmark, a roundabout, a cross road or a curve road, is smaller than a preset distance range, such as 100 meters. When the vehicle carrying the navigation device 1 moves into the preset distance range, the processing unit 12 will provide a speed limit message 26 based on the safety speed range and control the display unit 15 to display the image data of the speed limit message 26 and/or control the audio unit 16 to output the audio data of the speed limit message 26. As shown in FIG. 2, the display unit 15 can be a screen, and the audio unit 16 can be a speaker (not shown) or a stereo system. With these arrangements, the navigation device 1 can remind or warn the user by flashing the screen, changing the screen to a different color, ringing, playing a specific musical sound, and so on.

For the purpose of clarity, the navigation device 1 illustrated in the drawings and used for explaining the present invention is a navigator. However, it is understood the navigation device 1 in the present invention is not particularly limited in its structural type and manner of giving a warning and/or displaying different messages, data or information, which can be determined completely depending on the requirements and convenience in designing the navigation device 1. In other words, the navigation device 1 can be any electronic device that is able to display the navigation route 22, such as a notebook computer, a mobile phone, a personal digital assistant (PDA) or the like, depending on what is convenient for the user to use.

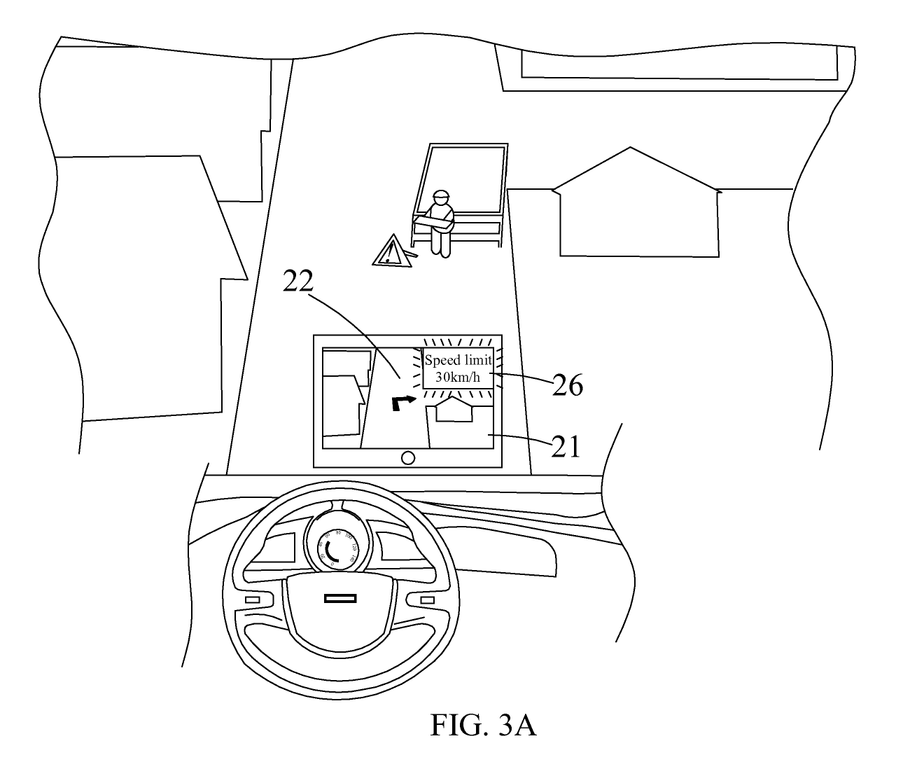

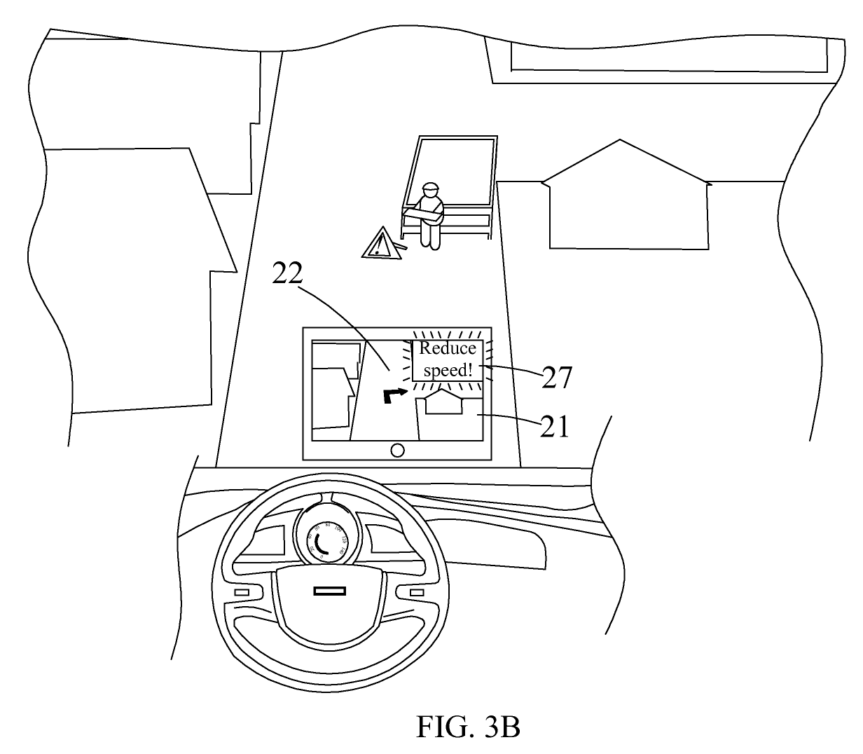

Please refer to FIGS. 3A and 3B, which show a second embodiment of the navigation device 1 of the present invention, respectively with a speed limit message 26 and a warning message 27 shown thereon. In FIG. 3A, when a distance between the vehicle carrying the navigation device 1, such as a car, and a waypoint, such as a cross road or a curve road, is smaller than a preset distance range, such as 200 meters, the processing unit 12 will then provide a speed limit message 26 based on the safety speed range, such as 30 km/h, and control the display unit 15 to display the image data of the speed limit message 26 and/or control the audio unit 16 to output the audio data of the speed limit message 26.

In FIG. 3B, when the distance between the vehicle carrying the navigation device 1 and the waypoint is smaller than the preset distance range, the processing unit 12 further determines whether the current speed of the vehicle with the navigation device 1 is higher than the safety speed range, such as 30 km/h. If yes, the processing unit 12 will immediately provide a warning message 27 and control the display unit 15 to display the image data of the warning message 27 and/or control the audio unit 16 to output the audio data of the warning message 27. The image data of the speed limit message 26 and the image data of the warning message 27 may be shown on the whole screen of the display unit 15. Alternatively, the image data of the speed limit message 26 and the image data of the warning message 27 may be shown on only part of the screen of the display unit 15 to highlight the messages. Further, the audio data of the speed limit message 26 and of the warning message 27 can also be output as a ringing sound or other musical sound without being limited thereto, so as to remind the user of the driving speed, lest the user should neglect the image data to cause any accident.

On the other hand, when the processing unit 12 determines the distance from the vehicle with the navigation device 1 to the waypoint is larger than the preset distance range, the processing unit 12 will then cancel the display of the speed limit message 26 and/or the warning message.

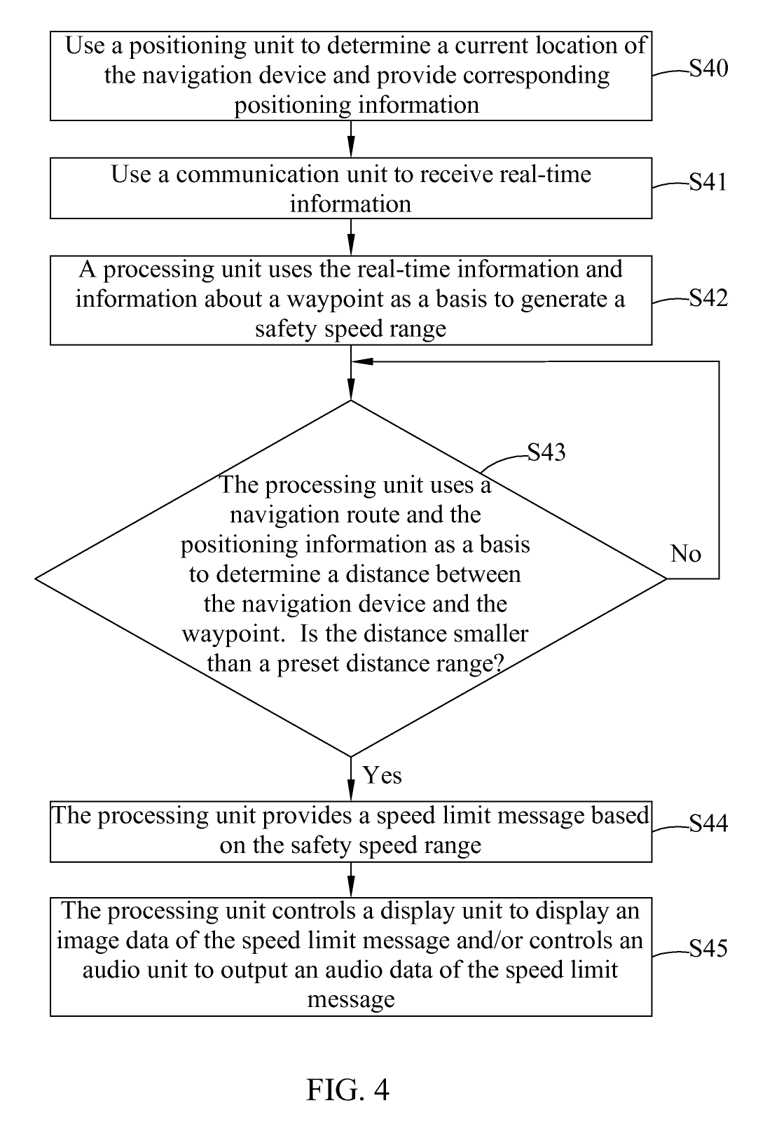

While the above description of the navigation device of the present invention has also described a concept of controlling the navigation device, the following will still give a more detailed description of the navigation device control method with reference to some flowcharts shown in FIGS. 4 to 6.

Please refer to FIG. 4 that is a flowchart showing the steps included in the navigation device control method according to the present invention. The control method is applicable to a navigation device that includes a positioning unit, a communication unit, a processing unit, a storage unit, a route planning unit, a display unit, and an audio unit; and the control method includes the following steps:

S40: Use the positioning unit to determine a current location of the navigation device and provide corresponding positioning information;

S41: Use the communication unit to receive real-time information;

S42: The processing unit uses the real-time information and information about a waypoint as a basis to generate a safety speed range;

S43: The processing unit uses a navigation route and the positioning information as a basis to determine whether a distance between the navigation device and the waypoint is smaller than a preset distance range;

S44: If yes, the processing unit immediately provides a speed limit message based on the safety speed range; and

S45: The processing unit controls the display unit to display an image data of the speed limit message and/or controls the audio unit to output an audio data of the speed limit message.

According to the navigation device control method of the present invention, the following step is further included after the step S45: the processing unit determines whether the distance between the navigation device and the waypoint is larger than the preset distance range; and if yes, the processing unit will then cancel the display of the speed limit message.

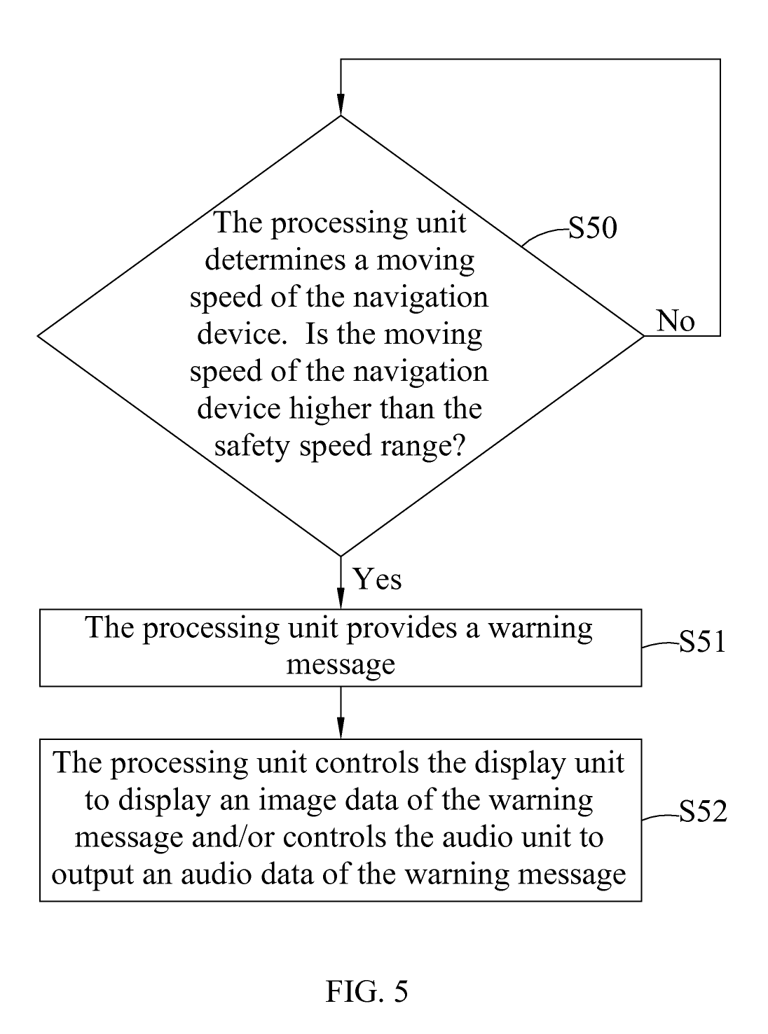

FIG. 5 is another flowchart showing the steps included in the navigation device control method of the present invention. As shown, the navigation device control method of the present invention further includes the following steps:

S50: The processing unit determines whether a current moving speed of the navigation device is higher then the safety speed range;

S51: If yes, the processing unit provides a warning message; and

S52: The processing unit controls the display unit to display an image data of the warning message and/or controls the audio unit to output an audio data of the warning message.

Wherein, the step S50 can be performed along with the step S44 after the step S43.

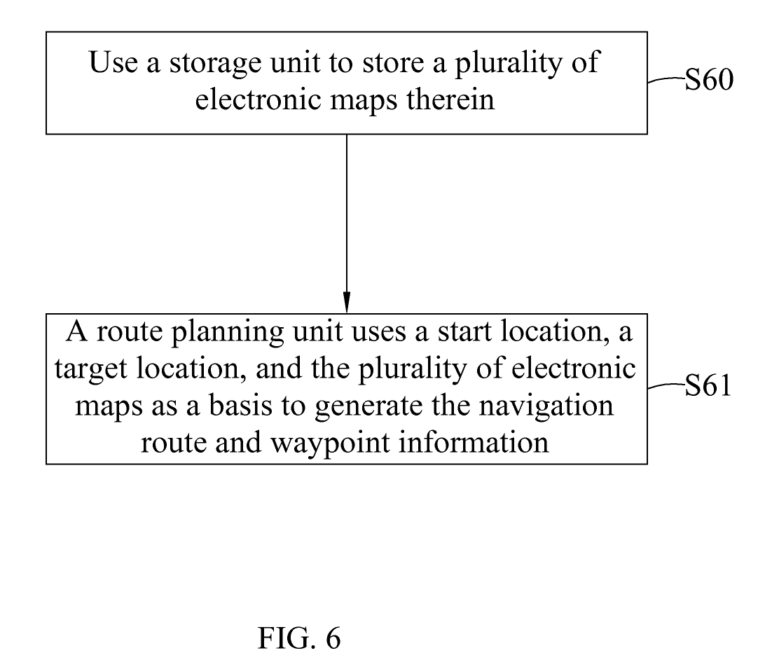

FIG. 6 is a further flowchart showing still further steps included in the navigation device control method of the present invention. As shown, the navigation device control method of the present invention further includes the following steps:

S60: Use the storage unit to store a plurality of electronic maps therein; and

S61: The route planning unit uses a start location, a target location, and the plurality of electronic maps as a basis to generate a navigation route and information about a waypoint; wherein the waypoint information includes at least one waypoint and coordinate data thereof.

Preferably, the steps S60 and S61 are performed before the step S40. However, the present invention does not particularly limit the sequence of the steps included in the navigation device control method.

Since the implementation of the above steps has already been recited in details in the previous description of the navigation device, it is not repeated herein.

In addition, the present invention also provides a program-storing computer-readable storage medium and a computer program product. A computer for use with the storage medium and the computer program product of the present invention includes, but not limited to, a positioning unit, a communication unit, a processing unit, a storage unit, a route planning unit, a display unit, and an audio unit. The storage medium of the present invention can be a compact disk, a hard disk, a flash drive, or other similar storage devices. When the computer loads and executes the program stored in the storage medium or the computer program product, it is able to implement at least the steps S40-S45, S50-S52, and S60-S61 of the navigation device control method as mentioned above.

In conclusion, with the program-storing computer-readable storage medium, the computer program product, the navigation device and the control method thereof according to the present invention, it is able to provide a safety speed range by determining the current location of the navigation device, the generated navigation route and the received real-time information. Further, when a distance between the navigation device and a waypoint is smaller than a preset distance range, the processing unit is able to provide a speed limit message based on the safety speed range to thereby remind the user of the navigation device to reduce the driving speed. And, when the user's driving speed is higher than the safety speed range, the processing unit can further provide a warning message to warn the user, lest the user should neglect the speed limit message. With these arrangements, the navigation device is helpful in ensuring the user's and pedestrians' safety.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A navigation device, comprising:
a positioning unit for determining a current location of the navigation device and providing corresponding positioning information;
a communication unit for receiving real-time information; and
a processing unit being electrically connected to the positioning unit and the communication unit, and using the real-time information and information about a waypoint as a basis to generate a safety speed range; the processing unit also using a navigation route and the positioning information as a basis to determine whether a distance between the navigation device and the waypoint is smaller than a preset distance range; if yes, the processing unit providing a speed limit message based on the safety speed range.

2. The navigation device as claimed in claim 1, wherein, after determining the distance between the navigation device and the waypoint is smaller than the preset distance range, the processing unit further determines whether a current moving speed of the navigation device is higher than the safety speed range; and if yes, the processing unit provides a warning message.

3. The navigation device as claimed in claim 2, wherein when the processing unit determines the distance between the navigation device and the waypoint is larger than the preset distance range, the processing unit cancels the provision of the speed limit message and the warning message.

4. The navigation device as claimed in claim 2, wherein both the speed limit message and the warning message include image data and audio data.

5. The navigation device as claimed in claim 4, further comprising:
a display unit being electrically connected to the processing unit for displaying the navigation route, the image data of the speed limit message, and the image data of the warning message; and
an audio unit being electrically connected to the processing unit for outputting the audio data of the speed limit message and the audio data of the warning message.

6. The navigation device as claimed in claim 1, further comprising:
a storage unit being electrically connected to the processing unit for storing a plurality of electronic maps therein; and the processing unit storing the real-time information received by the communication unit in the storage unit; and
a route planning unit being electrically connected to the processing unit and using a start location, a target location and the plurality of electronic maps as a basis to generate the navigation route and the waypoint information; and the waypoint information including waypoint and coordinate data thereof.

7. A navigation device control method applicable to a navigation device having a positioning unit, a communication unit and a processing unit, comprising the following steps:
using the positioning unit to determine a current location of the navigation device and provide corresponding positioning information;
using the communication unit to receive real-time information;
the processing unit using the real-time information and information about a waypoint as a basis to generate a safety speed range;
the processing unit using a navigation route and the positioning information as a basis to determine whether a distance between the navigation device and the waypoint is smaller than a preset distance range; and
if yes, the processing unit providing a speed limit message based on the safety speed range.

8. The navigation device control method as claimed in claim 7, further comprising the following steps:
after the processing unit determining the distance between the navigation device and the waypoint is smaller than the preset distance range, the processing unit further determining whether a moving speed of the navigation device is higher than the safety speed range; and
if yes, the processing unit providing a warning message.

9. The navigation device control method as claimed in claim 8, further comprising the following step:
if the processing unit determining that the distance between the navigation device and the waypoint is larger than the preset distance range, the processing unit canceling the provision of the speed limit message and the warning message.

10. The navigation device control method as claimed in claim 8, wherein both the speed limit message and the warning message include image data and audio data.

11. The navigation device control method as claimed in claim 10, further comprising the following steps:
using a display unit to display the navigation route, the image data of the speed limit message, and the image data of the warning message; and
using an audio unit to output the audio data of the speed limit message and the audio data of the warning message.

12. The navigation device control method as claimed in claim 7, further comprising the following steps:
using a storage unit to store a plurality of electronic maps therein; and the processing unit storing the real-time information received by the communication unit in the storage unit; and
a route planning unit using a start location, a target location and the plurality of electronic maps as a basis to generate the navigation route and the waypoint information; and the waypoint information including waypoint and coordinate data thereof.

13. A program-storing computer-readable storage medium, wherein the storage medium allows a computer to load and execute the program stored therein to thereby implement the navigation device control method as claimed in claim 7.

14. A computer program product, wherein the program product can be loaded and executed on a computer to thereby implement the navigation device control method as claimed in claim 7.
